(19) United States
(12) Patent Application Publication
(10) Pub. No.: US 2016/0237338 A1
(43) Pub. Date: Aug. 18, 2016

(54) Pretreatment of Subterranean Formations for Dendritic Fracturing

(71) Applicant: YPF TECNOLOGIA SA, Buenos Aires (AR)

(72) Inventors: Gustavo Luis Bianchi, La Plata (AR); Walter Morris, Neuquen (AR)

(21) Appl. No.: 15/027,186

(22) PCT Filed: Oct. 6, 2014
(86) PCT No.: PCT/IB2014/002539

§ 371 Date: Apr. 4, 2016

Related U.S. Application Data
(60) Provisional application No. 61/887,073, filed on Oct. 4, 2013.
(60) Provisional application No. 61/955,571, filed on Mar. 19, 2014.

(51) Int. Cl. C09K 8/68; E21B 43/26; E21B 43/25; C09K 8/66; C09K 8/86

(52) U.S. Cl. CPC C09K 8/68; C09K 8/665; C09K 8/86; E21B 43/25; E21B 43/26; E21B 43/04

(57) ABSTRACT

Provided are methods for pretreating a subterranean formation that include introducing into at least a portion of the subterranean formation: a first composition containing an oxidant in an aqueous base; and a second composition containing an acid and a compound that generates a non-oxygen gas upon reaction with the oxidant. Pretreating a subterranean formation according to these methods reduces the fracture toughness of the rock and establishes conditions favoring the growth of dendritic fracture.

### CROSS-REFERENCE TO RELATED APPLICATION

This application claims the benefit of U.S. Provisional Application No. 61/887,073, filed on Oct. 4, 2013, and of U.S. Provisional Application No. 61/955,571, filed Mar. 19, 2014. The contents of both provisional applications are hereby incorporated by reference herein in their entirety.

### FIELD OF THE INVENTION

Embodiments of the invention relate generally to subterranean treatment operations and, more specifically, to methods of pretreating a subterranean formation so as to reduce the fracture toughness of, and provide conditions favoring the development of dendritic fractures in, the subterranean formation.

### BACKGROUND OF THE INVENTION

The first experimental use of hydraulic fracturing reportedly took place 1947, and the first commercially successful applications occurred in 1949. Since then, the use of hydraulic fracturing methods has become widespread. As of 2010, it was estimated that 60% of all new oil and gas wells worldwide are being hydraulically fractured.

Hydraulic fracturing is a common production stimulation operation that generally involves pumping a treatment fluid (e.g., a fracturing fluid, hydraulic fluid, etc.) into a well bore that penetrates a subterranean formation at a sufficient hydraulic pressure to create or enhance one or more cracks (or “fractures”) in the subterranean formation. This type of hydrostimulation technique (also known as “fracking”) is commonly used in unconventional hard rock reservoirs of shale gas, tight gas, tight oil, and coal seam gas due to their extremely low permeability. The first experimental use of hydraulic fracturing began in 1947, and the first commercially successful applications occurred in 1949. As of 2010, it was estimated that 60% of all new oil and gas wells worldwide are being hydraulically fractured.

In some instances, a fracturing treatment may involve pumping a proppant-free, aqueous treatment fluid into a subterranean formation faster than the fluid can escape into the formation. As a result, the pressure in the formation rises and the formation breaks, forming fractures or enhancing one or more pre-existing fractures. The treatment fluid may comprise particulates, often referred to as “proppant particulates,” that are deposited in the fractures to form a “proppant pack.” The deposited proppant particulates may prevent the fractures from fully closing upon release of the hydraulic pressure, forming conductive channels through which fluids may flow to the well bore. Once at least one fracture is created and the deposited proppant particulates are substantially in place, the treatment fluid may be “broken” (i.e., the viscosity of the fluid is reduced), whereby the treatment fluid can be recovered from the formation.

Other common production stimulation operations employing treatment fluids include acidizing operations. Where the subterranean formation to be treated comprises acid-soluble components, such as those present in carbonate and sandstone formations, stimulation is commonly achieved by contacting the formation with a treatment fluid that comprises an acid. For example, where hydrochloric acid contacts and reacts with calcium carbonate in a formation, the calcium carbonate is consumed to produce water, carbon dioxide, and calcium chloride. After acidizing of the subterranean formation is completed, the water and salts dissolved therein can be recovered by bringing them to the surface (i.e., “flowing back” the well), leaving a desirable amount of voids (or “wormholes”) within the subterranean formation. These voids may further enhance the formation's permeability and/or increase the rate at which hydrocarbons subsequently may be produced from the formation. One method of acidizing, known as “fracture acidizing,” involves injecting a treatment fluid that comprises an acid into the subterranean formation at a pressure sufficient to create or enhance one or more fractures within the subterranean formation. Another method of acidizing, known as “matrix acidizing,” involves injecting a treatment fluid that comprises an acid into the formation at a pressure below which one or more fractures within the subterranean formation would be created or enhanced.

For a number of reasons, it is typically important that the treatment fluids used in these operations maintain a sufficient viscosity. For example, maintaining sufficient viscosity of the treatment fluid may be important for particulate transport during hydraulic fracturing, to create and/or enhance fractures within the subterranean formation, and to control and/or reduce fluid loss in the subterranean formation. To provide the desired viscosity, various friction reducing polymers, polymeric gelling agents, and inorganic acids and/or salts thereof have been added to the treatment fluids for use in a variety of subterranean treatment operations, as discussed in, e.g., U.S. Pat. No. 7,004,254, U.S. Pat. No. 8,622,134, U.S. Pat. No. 8,640,774, and U.S. Pat. No. 8,739,877 (incorporated herein by reference).

However, the use of such components in the hydraulic treatment solution has been found to be problematic in certain subterranean formations for a number of reasons. For example, whereas certain inorganic acids may thermally or hydrolytically degrade or corrode equipment placed in the subterranean formation, many gelling agents become unstable at high temperatures, thereby reducing the viscosity of the treatment fluid. The high activity loading of various polymers poses additional problems, because the highly concentrated, compacted and intertwined polymer molecules often have an insufficient opportunity to disperse, separate and expand in the water, which results in less viscosity build and less of a friction reducing effect. Moreover, currently used treatment fluids are not satisfactory because the induced fracture tends to propagate along a plane that is oriented according to the maximum acting stress, due to the chemical and physical properties of the treated rock, which results in the treatment fluid coming in contact with a reduced reservoir volume.

Besides the foregoing, a considerable amount of energy may be lost during the pumping of the fracturing fluid into the well bore due to friction between the fracturing fluid in turbulent flow and the formation and/or tubular goods (e.g., pipes, coiled tubing, etc.) disposed within the well bore. As a result of these energy losses, additional horsepower may be necessary to achieve the desired hydraulic treatment.

Despite the widespread use of hydraulic fracturing processes, there remains a need to increase their efficiency by reducing the energy required to produce fractures.

### SUMMARY OF THE INVENTION

The present disclosure generally relates to reducing the energy required to produce or enhance fractures in a subterranean formation by reducing the fracture toughness of the subterranean formation (rock), and by favoring the development of dendritic fractures so as to allow the treatment fluid to come in contact with a greater reservoir volume. More specifically, provided herein are methods of pretreating a subterranean formation so as to reduce the fracture toughness of, and provide conditions favoring the development of dendritic fractures in, the subterranean formation.

In embodiments, the methods for pretreating a subterranean formation may comprise introducing into at least a portion of the subterranean formation: (a) a first composition comprising an oxidant in an aqueous base; and (b) a second composition comprising an acid and a compound that generates a non-oxygen gas upon reaction with the oxidant. In certain embodiments, the first composition may be separately introduced into the subterranean formation before the second composition. Alternatively, the second composition may be separately introduced into the subterranean formation before the first composition. In other embodiments, both compositions may be mixed together prior to being introduced into the subterranean formation.

Other features and advantages of the various embodiments described herein will be readily apparent to those skilled in the art having the benefit of the following disclosure.

### BRIEF DESCRIPTION OF THE DRAWINGS

The drawings provided and referenced herein illustrate certain aspects of some embodiments of the invention, and should not be used to limit or define the invention.

FIG. 1 is a diagram showing the relationship between applied stress and the resulting crack length.

FIG. 2 is a graph describing the relationship between the sub-critical growth rate (V_{f}) of cracks formed in metals and rock and the Stress Intensity Factor (K_{I}).

FIG. 3 is a schematic drawing of an apparatus used for determining fracture toughness of cylindrical rock samples.

FIG. 4 is a graph that compares the composition of cement samples with that of shale rock.

FIGS. 5A and 5B show the two different modes of stress (I and II) as used in the lab tests discussed further below.

FIGS. 6A, 6B, 7A, 7B, 7C, 7D, 8A, 8B, 8C, and 8D are representative images showing the rock samples submitted for lab testing.

FIGS. 9A, 9B, 9C, 10A, 10B, and 10C are representative images showing the dendritic cracks produced in the rock samples during lab testing.

FIG. 11 is a graph showing the effect of the rate of stress application in the K_{IC} value for the blank condition in lab testing.

FIG. 12 is a graph showing the number of microseismic events that were validated for each fracturing step in a field pilot experiment.

FIG. 13 is a graph showing a comparison of the length of different fracturing steps of wells in a field pilot experiment.

FIG. 14 is a graph showing a comparison of the width of different fracturing steps of wells in a field pilot experiment.

FIG. 15 is a graph showing a comparison of the height of different fracturing steps of well sin a field pilot experiment.

FIG. 16 is a schematic representation of an ellipsoid representing an altered reservoir volume during hydraulic fracturing.

FIG. 17 shows the spatial distribution of micro events recorded in wells in a field pilot experiment.

### DETAILED DESCRIPTION

### A. DEFINITIONS

Other than in the operating examples, all numbers or expressions used herein to describe quantities of ingredients or reaction conditions are to be understood as modified in all instances by the term “about.” Accordingly, unless indicated to the contrary, any numerical parameters set forth in the following description and claims are approximations that may vary depending upon the desired properties sought to be obtained. Also, it should be understood that any numerical range recited herein is intended to include all sub-ranges therein. For example, a range of “1 to 10” is intended to also include all sub-ranges falling between and including the minimum and maximum values 1 and 10, respectively.

While compositions and methods are described in terms of, e.g., “comprising,” “containing,” or “including” various components or steps, the compositions and methods can also “consist essentially of” or “consist of” the various components and steps. Moreover, the indefinite articles “a” or “an”, as used in the claims, are intended to mean “one or more than one” of the element that the articles introduce.

As used herein, the term “fluid” refers to gases, liquids, and combinations of gases and liquids, as well as to combinations of gases and solids, and combinations of liquids and solids.

As used herein, the term “particulate” includes all known shapes of materials, including substantially spherical materials, fibrous materials, polygonal materials, and mixtures thereof.

As used herein in reference to a subterranean formation or rock, the term “stimulated” refers to subterranean formations or rocks that have been subjected to a non-naturally-occurring chemical or mechanical stress resulting in the creation or growth of one or more new or existing cracks, fissures, or fractures therein.

As used herein, the term “subterranean” refers to geologic strata occurring below the earth's surface.

As used herein, the term “treatment” (or “treating”) refers to any subterranean operation that uses a fluid in conjunction with a desired function and/or for a desired purpose. The term “treatment fluid” may be interchangeably used herein with the terms “hydraulic fluid” and “fracturing fluid” and does not imply any particular action by the fluid or any component thereof.

As used herein, the term “well bore” refers to a hole in the subsurface made by drilling or insertion of a conduit into the subsurface. The term “well,” when referring to an opening in the subsurface, may be used interchangeably with the term “well bore.”

As used herein, the term “annulus” means a region between a tubular body within a well bore and a surrounding tubular body or a surrounding formation.

### B. DISCUSSION OF SELECTED EMBODIMENTS

The present disclosure relates to methods for pre-treating a subterranean formation so as to reduce the fracture toughness of, and provide conditions favoring the development of dendritic fractures in, the subterranean formation. The methods may comprise introducing into at least a portion of the subterranean formation: (a) a first composition comprising an oxidant in an aqueous base; and (b) a second composition comprising an acid and a compound that generates a non-oxygen gas upon reaction with the oxidant.

The methods described herein may be used during or in preparation for any subterranean operation wherein a fluid may be used. Examples of suitable subterranean operations (or treatments) may include, but are not limited to: pre-flush treatments; after-flush treatments; drilling operations; hydraulic fracturing operations, sand control treatments (e.g., gravel packing); acidizing treatments, such as matrix acidizing or fracture acidizing; “frac-pack” treatments; well bore clean-out treatments; and other operations/treatments where the compositions described herein may be useful.

For example, in certain fracturing treatments, a treatment fluid (e.g., a fracturing fluid or a “pad fluid”) generally is introduced into a well bore that penetrates a subterranean formation at a sufficient hydraulic pressure to create or enhance one or more pathways (or fractures) in the subterranean formation. Aspects of the present disclosure similarly provide for introducing such treatment fluids into a subterranean formation to create or enhance fractures therein. As described herein, such treatment fluids are preferably introduced after an initial pretreatment of the subterranean formation with: (a) a first composition comprising an oxidant in an aqueous base, and (b) a second composition comprising an acid and a compound that generates a non-oxygen gas upon reaction with the oxidant (the first and second compositions being interchangeably referred to herein as a “two-composition fluid”).

According to methods of the invention, the two-composition fluid and/or the separate components thereof may be introduced into a portion of a subterranean formation by any means known in the art. In embodiments, the first and second compositions may be introduced into the portion of the subterranean formation at a rate and pressure sufficient to create or enhance one or more fractures in the portion of the subterranean formation. The portion of the subterranean formation that the aqueous treatment fluid is introduced will vary dependent upon the particular subterranean treatment. For example, the portion of the subterranean formation may be a section of a well bore, e.g., in a well bore cleanup operation.

In some embodiments, the first composition may be separately introduced into the subterranean formation before the second composition. Alternatively, the second composition may be separately introduced into the subterranean formation before the first composition. The time lapse, if any, between introduction of the first composition and the second composition, or between the second composition and the first composition if the order of introduction is reversed, may vary from seconds to days, such as, e.g., from 10 seconds to 48 hours, or from 1 minute to 30 minutes. In other embodiments, both compositions (referred to as the “first composition” and the “second composition”) may be mixed together prior to being introduced into the subterranean formation as a two-composition solution. In some embodiments, the first and second compositions may be introduced into the subterranean formation with a separator fluid.

Also provided herein are methods of creating fractures in a subterranean formation that may comprise: introducing into at least a portion of the subterranean formation a two-composition solution at a rate that exerts a sufficient pressure on the subterranean formation to create dendritic cracks or increase dendritic growth of existing cracks in the subterranean formation, wherein the introducing of the two-composition solution increases a stimulated rock volume and reduces a rock fracture toughness of the subterranean formation, and the two-composition solution includes: (a) a first composition comprising an oxidant in an aqueous base that generates a gas upon reaction with the stimulated rock of the subterranean formation; and optionally (b) a second composition comprising an acid and a compound capable of generating a non-oxygen gas upon reaction with the oxidant.

As provided above, the first composition generally comprises an oxidant in an aqueous base. The oxidant may be selected from known oxidants, and preferably has an oxidation potential greater than that of oxygen. In some embodiments, the oxidant may generate a gas as a result of interactions with a stimulated subterranean formation (rock). In certain embodiments, the oxidant may include at least one of: salts of permanganate (MnO₄²⁻), such as potassium (K⁺) permanganate, sodium (Na⁺) permanganate, and calcium (Ca²⁺ permanganate); salts of persulfate (S₂O₈²⁻), such as sodium (Na⁺) persulfate, potassium (K⁺) persulfate, and ammonia (NH₄⁺) persulfate; hydrogen peroxide (H₂O₂); potassium dichromate (K₂[Cr₂O₇]); and chlorine (Cl₂). Suitable aqueous bases may include (but are not limited to) fluids selected from the group consisting of fresh water, salt water, brine, seawater, and any combinations thereof. Generally, the water may be from any source, provided that it does not contain components that might adversely affect the stability and/or performance of the treatment fluid (i.e., the first and second compositions) employed in embodiments of the invention.

In some embodiments, the density of the aqueous base can be adjusted, e.g., to provide additional particle transport and suspension in the two-composition solution and/or to facilitate dissolving the viscoelastic surfactant into the aqueous base fluid. In some embodiments, the pH of the aqueous base may be adjusted (e.g., by a buffer or other pH adjusting agent), to reduce the viscosity of the fluid. In such embodiments, the pH may be adjusted to a specific level, which may depend on, among other factors, the type(s) of viscoelastic surfactant(s), amphiphilic polymers, salts, and other additives included in the fluid. Persons skilled in the art, having the benefit of the present disclosure, will recognize if and when such density and/or pH adjustments of the aqueous base are appropriate.

In certain embodiments, the first composition may comprise from 0.5% to 50% of the oxidant by weight, such as from 1% to 30% by weight, or from 2% to 10% by weight, or even 2% to 6% by weight.

As also provided herein, the second composition generally comprises an acid and a compound that generates a non-oxygen gas upon reaction with the oxidant. In embodiments, the acid of the second composition may be an organic or inorganic acid, as well as any salts or derivatives thereof. For example, suitable organic acids may include, but are not limited to, acetic acid, butyric acid, citric acid, glycolic acid, lactic acid, linoleic acid, 3-hydroxypropionic acid, palmitic acid, and any salts or derivatives thereof. Examples of suitable inorganic acids may include, but are not limited to, hydrochloric acid, hydrofluoric acid, sulfuric acid, nitric acid, perchloric acid, carbonic acid, hydrobromic acid, phosphoric acid, and any salts or derivatives thereof. In certain embodiments, the second composition may comprise from 10% to 20% by weight of an acid, such as from 10% to 15% by weight, 15% to 20% by weight, or about 15% by weight.

In some embodiments, the first composition may optionally also comprise an inorganic or organic acid that is the same or different from the acid of the second composition. Specifically, the first composition may comprise an oxidant and an organic or inorganic acid in an aqueous base. For example, in one embodiment, the first composition may comprise: from about 10% to 20% by weight, or about 15% by weight, of an acid.

With respect to the compound that generates a non-oxygen gas upon reaction with the oxidant, suitable compounds for use in the second composition may include at least one of, e.g., urea in an aqueous base, oxalic acid (HO₂CCO₂H), formic acid (HCO₂H), and formamide (HC(O)NH₂). In certain embodiments, the second composition may comprise the compound in an amount of from 0.5% to 20% by weight, such as from 0.5% to 15% by weight, from 2% to 10% by weight, from 0.5% to 5% by weight, or 3% by weight.

Additional additives may be included in the two-composition treatment fluids as deemed appropriate by one of ordinary skill in the art. Examples of such additional additives include, but are not limited to, salts, co-surfactants, corrosion inhibitors, particulates, acids, fluid loss control additives, surface modifying agents, tackifying agents, foamers, catalysts, clay control agents, biocides, friction reducers, antifoam agents, bridging agents, dispersants, flocculants, lubricants, viscosifiers, weighting agents, wetting agents, coating enhancement agents, and the like. For example, an acid may be included in the two-composition treatment fluids, among other things, for a matrix or fracture acidizing treatment. In fracturing embodiments, proppant particulates may be included in the aqueous treatment fluids to prevent the fracture from closing when the hydraulic pressure is suspended.

In some embodiments, the two-composition treatment fluids may comprise particulates, such as proppant particulates or gravel particulates comprising any material suitable for use in subterranean operations. Examples of suitable materials for these particulates include, but are not limited to, sand, bauxite, ceramic materials, glass materials, polymer materials, TEFLON (polytetrafluoroethylene) materials, nut shell pieces, cured resinous particulates comprising nut shell pieces, fruit pit pieces, cured resinous particulates comprising fruit pit pieces, wood, composite particulates, and combinations thereof. Moreover, fibrous materials that may or may not be used to bear the pressure of a closing/closed fracture may be included in the two-composition treatment solutions described herein to be used in certain embodiments. Suitable composite particulates may comprise a binder and a filler material, wherein suitable filler materials may include, but are not limited to, silica, alumina, fumed carbon, carbon black, graphite, mica, titanium dioxide, meta-silicate, calcium silicate, kaolin, talc, zirconia, boron, fly ash, hollow glass, microspheres, solid glass, and combinations thereof. The mean particulate size generally may range from about 2 mesh to about 400 mesh on the U.S. Sieve Series; however, in certain circumstances, other mean particulate sizes may be desired and suitable for use in the two-composition treatment fluids of the invention.

Non-limiting examples of suitable surfactants include fatty acid esters of mono-, di- and polyglycerols, for instance the monoleate, the dioleate, the monostearate, the distearate and the palmitostearate. These esters can be prepared, for example, by esterifying mono-, di- and polyglycerols, or mixtures of polyhydroxylated alcohols such as ethylene glycol, diethylene glycol, dipropylene glycol, 1,4-butanediol, 1,2,4-butanetriol, glycerol, trimethylolpropane, sorbitol, neopentyl glycol and pentaerythritol; fatty acid esters of sorbitan, for instance sorbitan monoleate, sorbitan dioleate, sorbitan trioleate, sorbitan monostearate and sorbitan tristearate; fatty acid esters of mannitol, for instance mannitol monolaurate or mannitol monopalmitate; fatty acid esters of pentaerythritol, for instance pentaerythritol monomyristate, pentaerythritol monopalmitate and pentaerythritol dipalmitate; fatty acid esters of polyethylene glycol sorbitan, more particularly the monooleates; fatty acid esters of polyethylene glycol mannitol, more particularly the monooleates and trioleates; fatty acid esters of glucose, for instance glucose monooleate and glucose monostearate; trimethylolpropane distearate; the products of reaction of isopropylamide with oleic acid; fatty acid esters of glycerol sorbitan; ethoxylated alkylaines; sodium hexadecyl phthalate; sodium decyl phthalate; and oil-soluble alkanolamides.

To provide a desired viscosity, polymeric gelling agents commonly are added to treatment fluids. The term “gelling agent” is intended include any gelling substance that is capable of increasing the viscosity of a fluid, e.g., by forming a gel. Examples of commonly used polymeric gelling agents include, but are not limited to, guar gums and derivatives thereof, cellulose derivatives, biopolymers, and the like.

Methods for pretreating a subterranean formation according to embodiments of the invention may include injecting a fluid comprising two separate compositions, preferably the first composition comprising an oxidant in an aqueous base and the second composition comprising an acid (organic or inorganic) and a compound that generates a non-oxygen gas upon reaction with the oxidant and/or with the stimulated rock. In other embodiments, a method for pretreating a subterranean formation may include: (1) mixing together (a) the first composition comprising an oxidant in an aqueous base and (b) the second composition comprising an acid (organic or inorganic) and a compound that generates a non-oxygen gas upon reaction with the oxidant; and (2) introducing the mixed compositions into the subterranean formation.

In certain embodiments, the first and second compositions may be introduced into the subterranean formation during a fracking operation and interact with the subterranean formation at a location away from the well bore. In such embodiments, the first and second compositions are generally introduced into the subterranean formation at a pressure that is higher than a fracture pressure of the subterranean formation. Generally, injecting (or pumping) the two-composition solution into the subterranean formation at an elevated pressure will hydraulically fracture the rock. As evidenced by the experimental data provided further below, this process creates a greater stimulated rock volume compared to conventional hydraulic fracture operations due to a reduced rock fracture toughness of the subterranean formation that has been pretreated with the two-composition fluid. Therefore, certain embodiments of the invention also provide methods of pretreating subterranean formations as described herein for hydraulic fracturing, resulting in increased branched dendritic growth of cracks in the subterranean formations and fissure propagation transversally to traction stresses, as compared to conventional techniques.

The geometry of hydraulic fractures generally depends on a number of factors, the most relevant of which include:
the geomechanical and petrophysical properties of the subterranean formation (i.e., rock);
the stress applied to the subterranean formation (anisotropy, S_{V}, S_{H}, Sₕ, Pₚ);
natural fractures in the subterranean formation (i.e., type, density, orientation);
the pumping rate (i.e., the flow rate and injection pressure);
characteristics of the fracturing fluid (viscosity, friction and loss control);
the design and completion type of the oil well in which treatment of the subterranean formation is performed; and
the rock-fluid interaction in the fracture tip.

In sum, branching and propagation of fractures, particularly the dendritic growth of fissures, is dependent on (1) the anisotropy, natural fractures, and heterogeneity of the subterranean formation (rock) being treated, and (2) the interaction of the fracturing fluid with the subterranean formation.

Induced propagation of fractures can be assessed by evaluating the Stress Intensity Factor (K_{I}) of the subterranean formation (rock). A material's Stress Intensity Factor is based on a function of loads/stress, crack size, and specimen geometry, and can provide an indication of the toughness or resistance of that material to fissure propagation. The Stress Intensity Factor (K_{I}) is represented by the following equation:

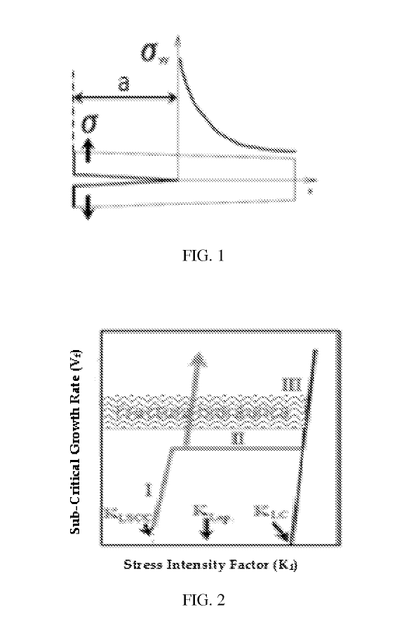

K_{I}=σ(απa)^{1/2}

where K_{I} is the fracture toughness, σ is the applied stress in MPa or psi, “a” is the crack length in meters or inches, and α is a dimensionless geometry factor that differs for each specimen. The relationship between applied stress and the resulting fracture length is shown in the diagram of FIG. 1.

There is furthermore a “critical value” (K_{IC}) of the Stress Intensity Factor that, when reached or surpassed, is indicative of the fracture being unstable and ready to propagate. Typical values for K_{IC} are generally in the range of 0.2-0.7 MPa·m^{1/2}. However, for certain materials and due to the environment action, cracks may propagate in a sub-critical way, i.e., when K_{I}<K_{IC}. This phenomenon is known as Stress Corrosion Cracking (K_{ISCC}), as first reported by Grenet (1899), and provides guidance to understanding the formation of natural fractures in many rock formations (Savalli, 2005).

As shown in FIG. 2, the sub-critical growth rate (V_{f}) of cracks in metals and rock comprises three different regions, designated as Region I, Region II and Region III. For Regions I and III the following relation, as reported by (Charles, 1958), applies:

Vf=A(K_{I}/K_{IC})ⁿ

where A is a constant and n depends on the kind of rock, usually 20<n<150.

In the presence of aqueous solutions, K_{ISCC} is reached at Vf<10⁻² m/s, and the hydraulic fracture is produced generally at Vf>10⁻¹ m/s. However, as discovered by the present inventors, modifying K_{ISCC} and extending the range of Vf>10⁻² m/s through the pretreatment methods described herein favors the dendritic growth of cracks. This is due to the pretreatment of the subterranean formation with the two-composition fluid, as the addition of the specific components to the fracturing fluid modifies the K_{ISCC} and extends the range of Vf>10⁻² m/s, and thus creates conditions favoring the dendritic growth of cracks. A further cause of this phenomenon is the high content of organic matter, called “kerogen,” in shale rock.

In addition to the above advantages, the addition of an oxidant to the fracturing fluid (i.e., the first composition) that is introduced into the subterranean formation results in “cleaner” fractures by increasing the flowback. Namely, the majority of organic materials in oil and gas shale are present in the form of kerogen. Kerogen is a high molecular weight heteropolymer that is insoluble in common organic solvents. Certain oxidants, such as KMnO₄, can break down the polymeric matrix, generating CO₂ and organic acids. Thus, when applying the two-composition fluid of the present invention to the subterranean formation, the oxidant reacts with kerogen to produce CO₂ and organic acids. This gas, in turn, favors the “cleaning” of the fracture and the water recovery, i.e., flowback. A similar effect is obtained by the reaction of an oxidant with HCl and the oxidant solution leading to the generation of CO and Cl₂.

Shale formations are mainly comprised of quartz, clay, carbonates and organic matter. Therefore, the fracturing fluid of the present invention is capable of reacting with carbonates, due to its HCl content, and with organic matter and clays, due to its oxidant content.

Embodiments of the invention are further described below in reference to the various examples. The following examples are merely illustrate exemplified embodiments, and are not intended to limit the scope of the disclosure. Unless otherwise indicated, all percentages are with respect to weight.

### C. EXAMPLES

Lab Tests

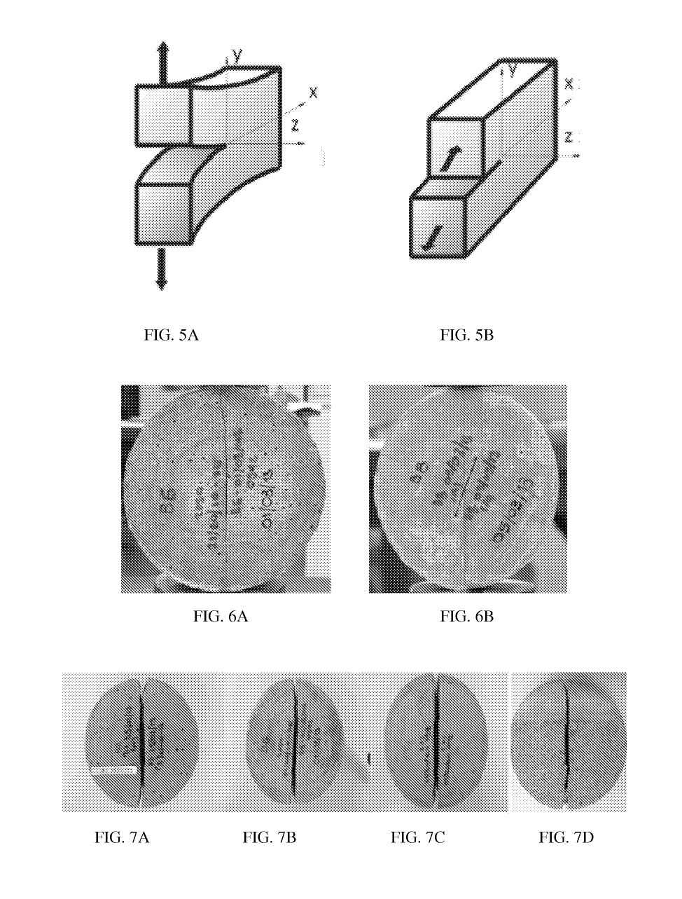

Cement samples were subjected to two different modes of stress (Mode I and Mode II), wherein the modes of stress are illustrated in FIGS. 5A and 5B, respectively. Specifically, Mode I included traction stress, whereas Mode II included shear stress. With respect to the Stress Intensity Factor of the samples:
K_{IC} denotes where the fracture propagates under tensile stress for sample subjected to Mode I; and
K_{IIC} denotes where the fracture propagates under shear stress for samples subjected to Mode II.

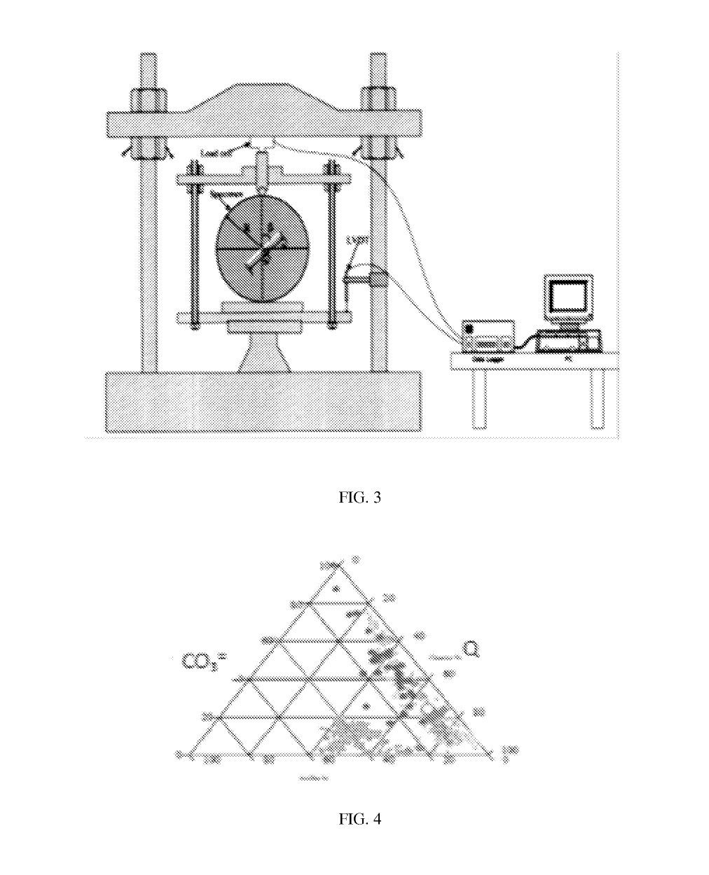

K_{IC} and K_{IIC} were determined in 60 cement samples that had a cylindrical shape with a 30 mm precast fracture in the center by using an apparatus as illustrated in FIG. 3. The composition of each cement sample simulated that of subterranean formations in oil wells currently under exploitation. The composition of the cement samples is shown in FIG. 4, which is representative of the composition of certain rocks found in shale and has the following composition:
Quartz: 64%
Carbonates: 24%
Clay: 8%
Others: 4%

The cement samples were soaked up with the oxidant in a 2-API solution, as described below, during a 24 hour period prior to undergoing the fracture tests under the two different modes of stress (Mode I: Traction, and Mode II: Shear) illustrated in FIGS. 5A and 5B. Two tested samples that were subjected to Mode I stress and Mode II stress, respectively, are shown in FIGS. 6A and 6B.

One of two types of treatment solutions was applied to the cement samples. The treatment solutions had the following compositions:

Solution 1: 2-API (2% KCl), considered as the “blank condition.”

Solution 2: 15% HCl+2% KMnO₄ Oxidant.

Results of Lab Tests

Stress Mode I: The obtained values for K_{IC} for samples subjected to Mode I were as follows: 0.34<K_{IC}<0.6 MPa·m^{1/2}. FIGS. 7A-7D are images of several samples after having undergone the test. Typically, a sample tested under Mode I will split in two slices. However, of the tested samples, the samples that were tested in the HCl solution containing the oxidant (rather than in the “blank condition” fluid) showed a branched crack pattern indicating that the fracture becomes dendritic.

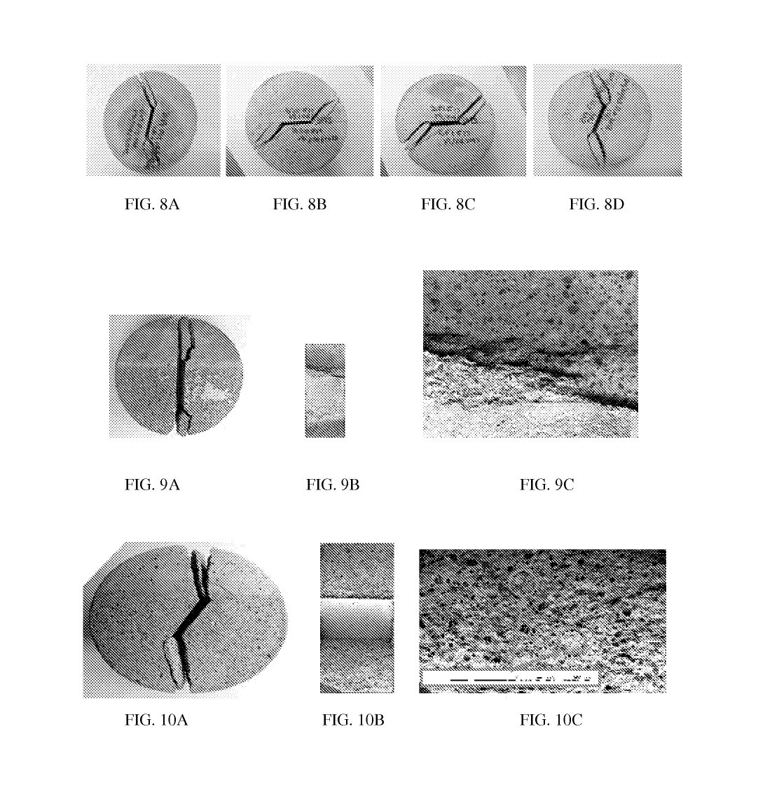

Stress Mode II: The obtained values for K_{IIC} for samples subjected to Mode II were as follows: 0.52<K_{IIC}<0.72 MPa·m^{1/2}. FIGS. 8A-8D are images of several samples after having undergone the test. As further shown in the images of FIGS. 9A-9C and 10A-10C, the dendritic cracks produced in other samples can be branched or intergranular.

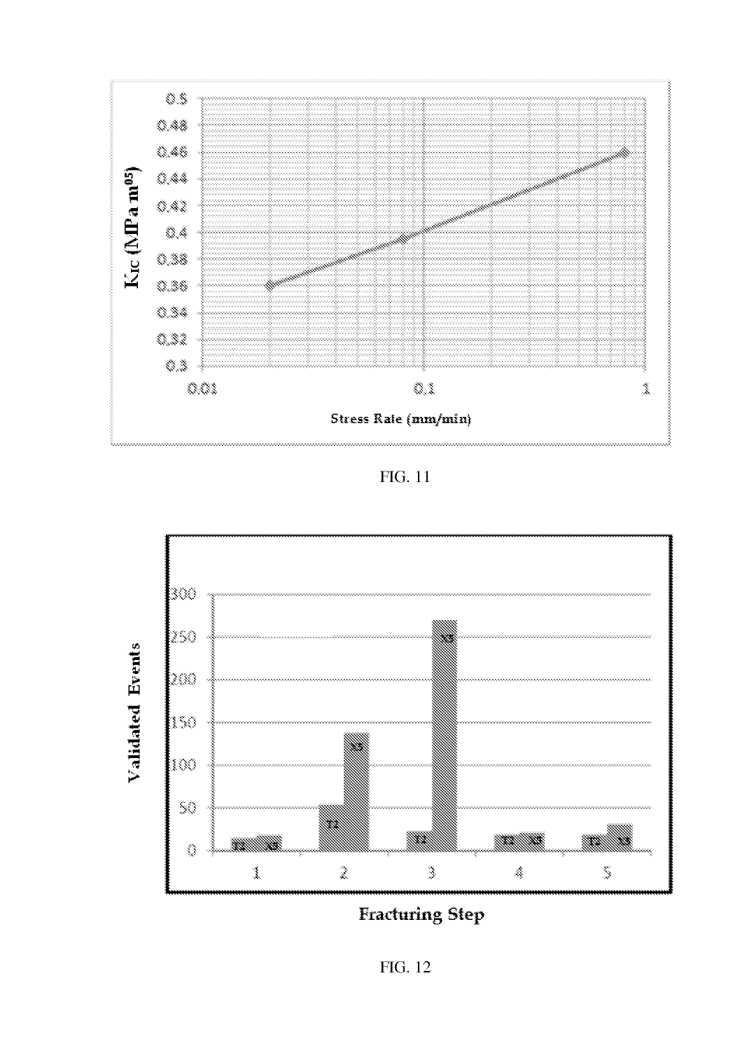

FIG. 11 shows the effect of the stress application rate n on the K_{IC} value of samples tested under the “blank condition” (i.e., the 2-API solution). Results of tests carried out in dry condition, i.e., without treating the samples with the solution, showed only a slight variation of K_{IC} regarding the stress application rate. However, results of specific tests further showed that this effect is greater when the oxidant composition is applied. This indicates that the medium affects rock toughness.

The above tests demonstrate that: (1) the K_{IC} of the subterranean formation (rock) decreases when the stress application rate decreases, i.e., with a longer interaction time between the fluid and the crack tip (volume/treatment flow rate); and (2) the crack branching increases (i.e., dendritic fracturing) by:
(a) adding the oxidant composition in acidic media, and/or
(b) increasing the contact time of the acidic composition when the crack starts (volume and/or flow rate).

Without wishing to be bound by theory, it may be hypothesized that: natural fissure subcritical growth processes in subterranean formations (rock) generally take place at very low propagation rates (<10⁻⁴ m/s). In these cases, the propagation rate is controlled by chemical dissolution process of the rock cementing material and the species transport from and towards the fissure tip.

The subcritical propagation rate of induced fissures may be substantially increased by the addition of strong oxidant agents to the fracturing fluid and letting it interact with the rock at the fissure tip. As a result, the propagation process is much faster at the points where the oxidant reacts with the compounds that are more oxidant-sensitive, like organic matter and unstable minerals.

In turn, the reaction products generally show greater fragility than their matrix, favoring the fissure propagation transversally to traction stresses. Therefore, the fissure propagation rate is ruled by the reaction kinetics between the oxidant agent and the less stable rock compounds of the subterranean formulation, characterized by the reaction kinetic constant K. The reaction rates are primarily dependent on temperature, nature and concentration of the reacting species, and the use of catalysts.

The relationship between constant K and temperature is represented by Arrhenius' equation as follows:

k=Ae^{(-E}^{_{α}}^{/RT)}

The reaction rate for a simple exemplary reaction, such as aA+bB→gG+hH, is represented by the following equation:

vᵣ=K·[A]^{α}·[B]^{β}

where [A] and [B] are the reactant concentrations, the exponents correspond to the kinetic coefficients of the reactants, and vᵣ is expressed as concentration units over time (e.g., (mol/l)/s).

Based on the relationship equations set forth above, persons skilled in the art will recognize that a high concentration of reactants will lead to a higher subcritical propagation rate, along with a high kinetic constant K. Taking as an example a metal corrosion process under stress in which the fissure subcritical propagation rate (Vp) is governed by the surface diffusion of vacancies towards the tip thereof, Vp is given by the following expression:

$$Vp = \frac{{D}_{s}}{L} [ exp ( \frac{σ \cdot {a}^{3}}{k \cdot T} ) - 1 ]$$

where Vp is in m/s, Ds is a metal or alloy surface self-diffusion coefficient in m²/s, L is the diffusion path length in m, σ is the stress at the fissure end in N/m², a is the atomic diameter in meters, k is Boltzmann's constant in J/K, and T is the work temperature in K. In the case of rocks, vacancies at the fissure end are generated by the chemical action of the reaction product and bond breaking of reactants (oxidants) that are present in the medium.

Referring back to the present examples, the fissure subcritical propagation rate is given by the following expression:

$$Vp = χ \cdot {v}_{r} [ exp ( \frac{σ \cdot {a}^{3}}{k \cdot T} ) - 1 ]$$

where Vₚ is in m/s, χ is a coefficient in ml/mol that depends on the reaction products and the rock compound size represented by “a” forming part of the reaction.

Field Tests

The following tests were carried out to evaluate, on a field-scale, the effect of a pre-treatment with a two-composition fluid according to methods described herein on the fracture toughness of shale rocks. A pilot experiment was therefore carried out on a well-scale in order to assess the effect of a two-composition fluid according to embodiments of the invention. The experiment was carried out as part of a hydraulic fracturing operation in a subterranean shale formation located in the region known as “Vaca Muerta” in Argentina. The compositions (of the two-composition fluid) used in the experiments were respectively designated as Solution A and Solution B.

Solution A comprises an acid and an organic compound capable of generating a non-oxygen gas upon reaction with an oxidant, while Solution B is a fluid comprising an oxidant in an aqueous base, optionally further comprising an inorganic or organic acid.

As used in this field pilot test, the Compositions A and B in an aqueous base contained:
Composition A: 15% HCl; 3% urea; and 3% citric acid
Composition B: KMnO4 4%.

Two neighboring wells having the same completion type were selected for use. A test solution was injected into one of the wells prior to the main fracture treatment, while the other well was kept as a test control. The same main fracture treatment was performed on the subterranean formations in both wells. Treatment incidence was evaluated by microseismic recording.

The results obtained showed that the well that was pre-treated with the Compositions A and B presented a higher number of microseismic events than the control well (without pre-treatment with Compositions A and B), and that the altered reservoir volume (VRA) due to the pre-treatment was two-fold higher.

Experimental Design for Field Tests

With an object being “Vaca Muerta” subterranean formation, a location therein was selected. The selected location contained 4 wells, identified as T2, M3, T4, and X5. At the zone of interest, the wells have a vertical path approximately 270 m apart from each other in a square pattern. The 4 wells involved in the Field Tests were further designated as follows:
T2: Control Well—fracture with no test fluid
M3: Monitor Well—monitor for microseismic activity
X5: Test Well—fractured with the two-composition fluid
   (Compositions A+B)
T4: not part of the pilot test
   (no microseismic activity was recorded)

Five fracture stages were performed in each well. A main fracturing fluid consisting of a sequence of water-based fracture fluids with an average of 6,000 proppant bags was delivered in each stage by pumping at a high regimen (between 60 and 70 bpm).

In the case of well X5, prior to the main fracturing treatment, the well was pre-treated by pumping 12 m³ of the test fluid system composed of a batch of Composition A, followed by a 0.5 m³ water separator, and finally a batch of Composition B. Proportions of these batches varied as a function of the fracture stage based on the chemical composition of the subterranean formations (rocks). The volumes of the respective Compositions A and B are provided in Table 1 below.

TABLE 1

| Stage | Solution A | Solution B |
|---|---|---|
| 1 (base of the formation) | 4 | 8 |
| 2 | 6 | 6 |
| 3 | 8 | 4 |
| 4 | 8 | 4 |
| 5 (top of the formation) | 10 | 2 |

In all stages except for stage #5 (where the test pre-treatment was pumped at a flow rate of 15 bpm) the sequence of test fluids was delivered into the subterranean formation at a low regimen (3 bpm).

Results of Field Tests

The results of the tests were evaluated by comparing the analysis of the microseismic records obtained for the wells T2 and X5. This analysis was performed by comparing the number of events recorded in each of the stages, and observing the spatial distribution with reference to the specific well location. From this information, the dimensions of the hydraulic fracturing were estimated: Length (L), Width (W), and Height (H). A summary of the number of microseismic events recorded in the 5 fracturing stages for the wells T2 and X5, and the estimated (based on this information) geometry/dimensions of the fractures created is provided in Table 2 below.

TABLE 2

| | T2 | | | | X5 | | | |
|---|---|---|---|---|---|---|---|---|
| | # | Length | Width | Height | # | Length | Width | Height |
| Stage | events | (m) | (m) | (m) | events | (m) | (m) | (m) |
| 1 | 15 | 323 | 149 | 65 | 18 | 245 | 109 | 120 |
| 2 | 54 | 447 | 68 | 96 | 138 | 528 | 112 | 141 |
| 3 | 23 | 293 | 56 | 81 | 270 | 448 | 115 | 81 |
| 4 | 19 | 278 | 155 | 66 | 21 | 218 | 80 | 119 |
| 5 | 19 | 220 | 87 | 65 | 31 | 248 | 117 | 96 |

A comparative graph showing the number of validated events for each fracturing step in the two wells (T2 and X5) is provided in FIG. 12. From this comparison, it is readily evident that the well X5 (which was pre-treated with the Compositions A+B) displays a higher number of validated events than well T2 in all 5 of the fracturing steps. It should also be noted that the number of recorded events decreased significantly following fracturing Stage 3 due to a sudden increment in noise from other sources.

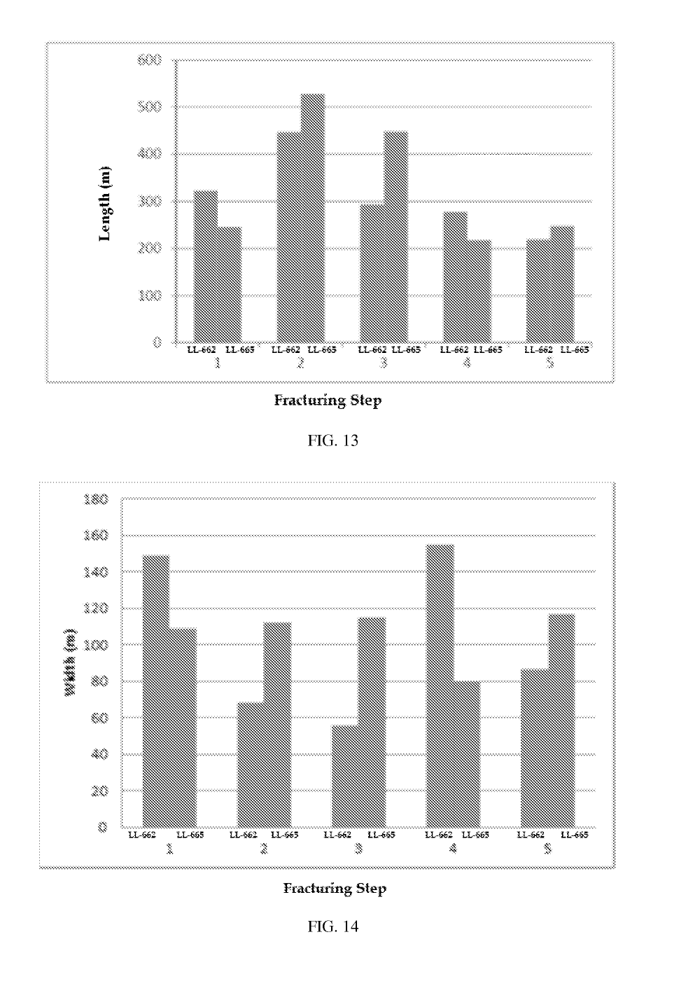

A comparison of the Length, Width, and Height dimensions of the fractures in the two wells is provided in FIGS. 13-15, respectively. Noting that an object of the pre-treatment field test carried out in Well X5 was to promote dendritic (branched) growth of the fractures during hydraulic stimulation of the subterranean formation, it would be expected to observe an incidence in the geometry of the fracture due to radial growth of the fractures (i.e., Width) and due to the fact that the fluid will affect primarily the zone near the well bore (i.e., Height).

However, as can be seen in FIG. 13, fracture lengths in both wells varied considerably per stage. For example, in Stages 1 and 4, larger fracture lengths were observed for the Well T2, whereas larger fracture lengths were observed for the well X5 in Stages 2, 3, and 5. Upon averaging the fracture lengths of both wells, the result is found to be comparable (320 m). With respect to the observed fracture widths, FIG. 14 shows that—with the exception of Stages 1 and 4—the fractures obtained in Well X5 were wider than those obtained in Well T2. Upon averaging the fracture widths of both wells, the average values turned out to be 111.4 m for Well X5 and 74.6 m for Well T2. Finally, a comparison of the growth in height of fractures obtained in both wells (as shown in FIG. 15) demonstrates that Well X5 had the highest fracture growth, practically in all Stages.

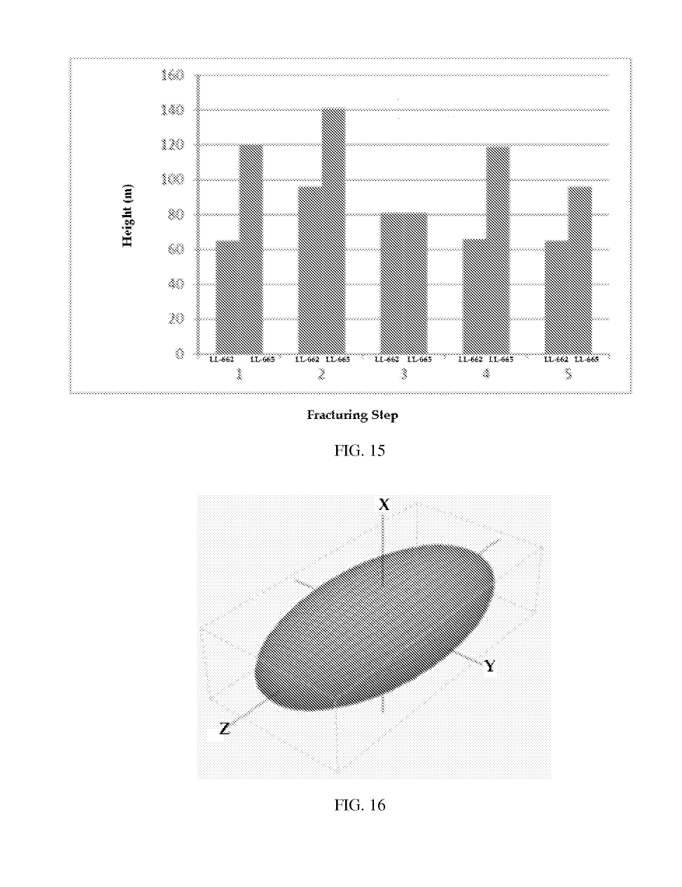

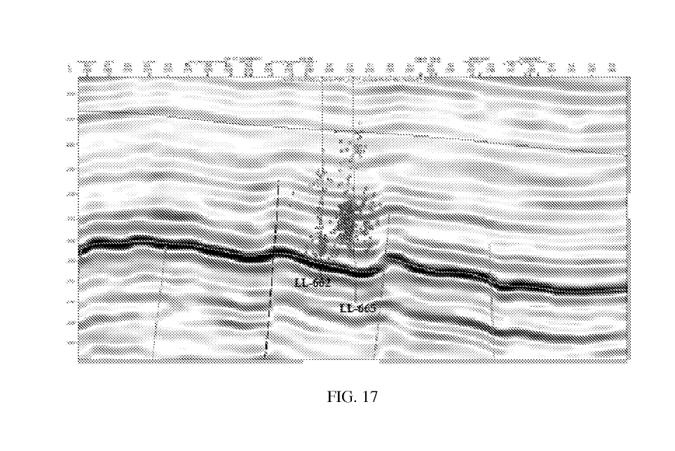

Although the microseismic records do not always allow for determining the simulated reservoir volume (SRV), as this also depends on the packing of fractures with proppant, the microseismic detection of distribution of events allows for establishing the reservoir volume that was altered during the fracturing operation. That is, if the Altered Reservoir Volume (ARV) is assumed to have a spatial geometry similar to that of an ellipsoid, as shown in FIG. 16, then the ARV may be determined from the dimensions L, W, and H according to the following equation:

ARV=4/3(LWH)

The ARV of all five fracturing Stages can therefore be determined based on the fracture dimensions provided in Table 2. Specifically, Table 3 provides the ARV values calculated from the values of L, W, and H, as determined from the microseismic records. Furthermore, the total altered reservoir volume (ARV_{T}) is obtained from the addition of the 5 fracturing stages.

TABLE 3

ARV (m³)

| Stage | T2 | X5 |
|---|---|---|
| 1 | 1.31E+07 | 1.34E+07 |
| 2 | 1.22E+07 | 3.49E+07 |
| 3 | 5.56E+06 | 1.75E+07 |
| 4 | 1.19E+07 | 8.69E+06 |
| 5 | 5.21E+06 | 1.17E+07 |
| Total | 4.80E+07 | 8.61E+07 |

These above results show that the altered reservoir volume (ARV) of Well X5 was nearly double the ARV of Well T2. The spatial distribution of events validated in both wells is shown in FIG. 17, with Well T2 shown on the left and Well X5 shown on the right. From this spatial distribution of recorded micro events, it can be clearly seen that the reservoir volume altered by the fractures is greater in Well X5 where the pretreatment with Compositions A+B was carried out. The image in FIG. 17 further shows that Well X5, where the fluid sequence of Compositions A+B was injected, presented a higher density of microseismic events compared to the “control” Well T2.

What is claimed is:

1. A method for pre-treating a subterranean formation, comprising introducing into at least a portion of the subterranean formation:
(a) a first composition comprising an oxidant in an aqueous base; and
(b) a second composition comprising an acid and a compound that generates a non-oxygen gas upon reaction with the oxidant.

2. The method according to claim 1, wherein the first composition is separately introduced into the subterranean formation before the second composition.

3. The method according to claim 1, wherein the second composition is separately introduced into the subterranean formation before the first composition.

4. The method according to claim 1, wherein the first composition and the second composition are mixed together prior to introduction into the subterranean formation.

5. The method according to claim 1, wherein the oxidant has an oxidation potential greater than oxygen.

6. The method according to claim 1, wherein the oxidant is at least one member selected from the group consisting of salts of permanganate, salts of persulfate, hydrogen peroxide, potassium dichromate, and chlorine.

7. The method according to claim 6, wherein the oxidant is a potassium or sodium salt of permanganate.

8. The method of claim 6, wherein the oxidant is an ammonium, sodium or potassium salt of persulfate.

9. The method according to claim 1, wherein the compound that generates a non-oxygen gas upon reaction with the oxidant is at least one member selected from the group consisting of urea, oxalic acid, formic acid, and formamide.

10. The method according to claim 1, wherein the compound that generates a non-oxygen gas upon reaction with the oxidant is urea.

11. The method according to claim 1, wherein the acid of the second composition is at least one organic acid selected from the group consisting of acetic acid, butyric acid, citric acid, glycolic acid, lactic acid, 3-hydroxypropionic acid, palmitic acid, linoleic acid, and any salts or derivatives thereof.

12. The method according to claim 1, wherein the acid of the second composition is at least one inorganic acid selected from the group consisting of hydrochloric acid, hydrofluoric acid, sulfuric acid, nitric acid, perchloric acid, carbonic acid, hydrobromic acid, phosphoric acid, and any salts or derivatives thereof.

13. The method according to claim 1, wherein the aqueous base of the first composition is a fluid selected from the group consisting of fresh water, salt water, brine, seawater, and any combinations thereof.

14. The method according to claim 1, wherein the first composition comprises from 0.5% to 50% of the oxidant in an aqueous base.

15. The method according to claim 1, wherein the first composition further comprises an acid in an amount of from 1% to 20% by weight of the composition.

16. The method according to claim 1, wherein the second composition comprises from 0.5% to 20% by weight of the compound that generates a non-oxygen gas upon reaction with the oxidant.

17. The method according to claim 1, wherein the acid of the second composition is hydrochloric acid.

18. The method according to claim 17, wherein the compound that generates a non-oxygen gas upon reaction with the oxidant is urea.

19. The method according to claim 18, wherein the second composition comprises from 10% to 20% by weight of hydrochloric acid and from 0.5% to 5% by weight of urea.

20. The method according to claim 1, wherein the pre-treatment of a subterranean formation is part of an oilfield operation selected from the group consisting of a drill-in operation, a fracking operation, a well bore cleanup operation, a viscous sweep operation, a fines control operation, a gravel packing operation, a frac packing operation, an acidizing operation, a stimulation operation, and any combinations thereof.

21. The method according to claim 1, wherein the first and second compositions are introduced into the subterranean formation during a fracking operation and interact with the subterranean formation at a location away from the well bore.

22. The method according to claim 1, wherein the first and second compositions are introduced into the subterranean formation at a pressure that is higher than a fracture pressure of the subterranean formation.

23. The method according to claim 1, wherein introducing the first and second compositions into at least a portion of the subterranean formation reduces a fracture toughness of the subterranean formation.

24. The method according to claim 1, wherein introducing the first and second compositions into at least a portion of the subterranean formation produces conditions that favor formation of dendritic fractures during a subsequent hydraulic fracturing of the pretreated subterranean formation.

25. A method of creating fractures in a subterranean formation, comprising:
introducing into at least a portion of the subterranean formation a two-composition solution at a rate that exerts a sufficient pressure on the subterranean formation to create dendritic cracks or increase dendritic growth of existing cracks in the subterranean formation,
wherein
the introducing of the two-composition solution increases a stimulated rock volume and reduces a rock fracture toughness of the subterranean formation, and
the two-composition solution includes:
(a) a first composition comprising an oxidant in an aqueous base that generates a gas upon reaction with the stimulated rock of the subterranean formation; and
(b) a second composition comprising an acid and a compound capable of generating a non-oxygen gas upon reaction with the oxidant.

26. The method according to claim 25, wherein the introducing of the two-composition solution comprises separately introducing, in any order, the first and second compositions into the subterranean formation.
